(19) United States
(12) Patent Application Publication
(10) Pub. No.: US 2020/0334724 A1
(43) Pub. Date: Oct. 22, 2020

(54) PEER-TO-PEER BILL SHARING PAYMENT APPLICATION

(71) Applicant: Peter Garrett, San Francisco, CA (US)

(72) Inventor: Peter Garrett, San Francisco, CA (US)

(21) Appl. No.: 16/853,314

(22) Filed: Apr. 20, 2020

Related U.S. Application Data
(60) Provisional application No. 62/836,649, filed on Apr. 20, 2019.

(51) Int. Cl. G06Q 30/04; G06Q 20/22; G06Q 20/20; G06Q 30/06; G06Q 20/14; G06Q 20/10; G06Q 20/32; G06Q 40/02; G06K 9/22; H04L 29/08

(52) U.S. Cl. CPC G06Q 30/04; G06K 2209/01; G06Q 20/204; G06Q 30/0641; G06Q 30/0633; G06Q 20/14; G06Q 20/102; G06Q 20/108; G06Q 20/3223; G06Q 40/02; G06Q 20/3267; G06K 9/228; H04L 67/1061; H04L 67/18; H04L 67/20; G06Q 20/223

(57) ABSTRACT

A peer to peer (P2P) bill sharing payment platform includes a first set of coded instructions instructing a user's smart phone to [1] establish a local network connection between the smart phone and a merchant's point of sale (POS) system, [2] receive an interactive ordering interface from the merchant's point of sale (POS) system with the interactive ordering interface displayed on a display device native to the smart phone, [3] record digital input from the user activity of selecting items listed in the interactive to ordering interface, the platform including a second set of coded instructions contained on a server, the second set of code instructing the server to receive order data over the network from the user's smart phone through the interactive order interface, and [4] send an electronic bill to the user's smart phone over the network and to receive payment from the user's smart phone over the network.

### CROSS-REFERENCE TO RELATED DOCUMENTS

The present invention claims priority to a U.S. patent application Ser. No. 62/836,649 entitled Peer-to-peer Bill Sharing Payment Application for large Parties filed on Apr. 20, 2019 the disclosure of which is included herein at least by reference.

### BACKGROUND OF THE INVENTION

### 1. Field of the Invention

The present invention is in the field of financial payment applications including bill sharing and pertains more particularly to a bill sharing platform operated by a plurality of users that share a cost among themselves.

### 2. Discussion of the State of the Art

Mobile Peer-to-peer transactions (also referred to as person-to-person transactions, P2P transactions, or P2P payments) are electronic money transfers made from one person to another through an intermediary, typically referred to as a P2P payment app (such as Venmo or Cash App). Mobile P2P payments offer a convenient alternative to traditional payment methods.

P2P Payment applications require each user's account to be electronically linked to one or more of the user's bank accounts, debit cards, or credit cards. Both the sender and the recipient must have the same P2P payment application (Venmo-to-Venmo or Cash App-to-Cash App, etc.) To send or receive money, a user must select which payment source they would like to use for the transaction (a linked bank account, debit card, credit card or their P2P payment app account with available funds to send money).

The amount of money sent in the scenario just described above is deducted from the user's selected funding source and the transaction is recorded. The recipient of the money receives the funds into their P2P payment app account instantaneously. The recipient then has the option of either transferring the money they received into their linked bank account(s) or spending the money via the debit card associated with their P2P payment application account.

Many business entities have developed P2P transaction capabilities since P2P has taken hold in the market space, increasing the competition in the market space and improving convenience for the consumer. P2P payment application technology has not changed very much since its inception despite its proliferation. There are many limitations to the existing P2P technology that need to be overcome in order to make the technology more palatable to consumers.

For example, P2P payment applications do not allow a user to send money to a recipient where the user divides the total amount sent among multiple payment sources like two or more credit or debit cards or a combination of those. A feature like that would be very palatable to a user who may not have enough funds in a single payment account to cover the amount required to be transferred to the recipient.

Another drawback is that P2P payment applications do not support accurate bill sharing among multiple users for example sharing a large restaurant bill. P2P payment application users must instead elect one person among them within the large party to pay the bill. The payer must then collect each of the other's portion of the bill by having them individually send money to him or her through the P2P application. Not everyone uses the same P2P application, further complicating the problem. If one or more people at the table are not using the same P2P payment application then they have to download and install the application everyone else has or they have to daisy chain their payments through others in the group that have the same version as the payer.

It has occurred to the inventor that a new P2P application feature or features are required to improve the capabilities of P2P payment applications in general, including facilitation of payments shared by multiple users. Therefore, what is clearly needed is a P2P application and method that enables multiple consumers sharing a bill to use multiple P2P payment application accounts as a collective source account to pay a bill including sharing of tips and other fees.

### BRIEF SUMMARY OF THE INVENTION

According to at least one embodiment of the present invention, a peer to peer

(P2P) bill sharing payment platform is provided and includes a first set of coded instructions contained on a non-transitory medium resident on a user's smart phone connected to a network, the first set of code instructing the user's smart phone to (a) establish a local network connection between the smart phone and a merchant's point of sale (POS) system, the connection, a P2P connection allowing merchant electronic recognition of the identification of the user, (b) receive from the merchant's POS system over the network an interactive ordering interface, the interactive ordering interface displayed on a display device native to the smart phone, (c) record digital input from the user activity of selecting items listed in the interactive ordering interface and a second set of coded instructions contained on a non-transitory medium resident on a server connected to the network, the second set of code instructing the server to (d) receive order data over the network from the user's smart phone through the interactive order interface, (e) generate and or send a generated electronic bill to the user's smart phone over the network, and (f) receive payment from the user's smart phone over the network.

In a preferred embodiment, the user is one of a party of users sharing the bill. In one embodiment, the network is the Internet network including any local connected sub networks. In one embodiment, the POS system in (a) is accessed as a service hosted on the Internet and is subscribed to by the merchant. In another embodiment, the POS system in (a) is a peer to peer (P2P) server hosted on a local network device owned and controlled by the merchant.

In a preferred embodiment, the interactive order interface of (b) includes an interactive selection mechanism associated with each line item enabling user selection of line items in the interactive order interface. In a variation of this embodiment, the interactive order interface of (b) further includes an interactive mechanism for enabling addition of user data identifying one or more other users to be associated to a user-selected line item signifying to the merchant an intent to share the selected item among the added users.

In one embodiment, the order data received in (d) from the user's smart phone through the interactive order interface includes order data input by the user and usernames of any other users sharing one or more line items with the ordering user. In one embodiment, all users in the party establish the connection in (a). In one embodiment, the server sends each user in a party of users a version of the bill in (e) and wherein the server receives payment from each of the users through their connected smart phones in (f). In another embodiment, the server sends one user in a party of users a version of the bill in (e) and wherein the server receives payment from that user through the user's smart phone (f) and wherein the server collects the funds from more than one account held by the user to satisfy payment of the bill. In one embodiment, the payments received from individual users are debited from more than one account held by those users.

According to another embodiment of the present invention, a peer to peer (P2P) bill sharing payment platform is provided and includes a set of coded instructions contained on a non-transitory medium resident on a user's smart phone connected to a network, the set of code instructing the user's smart phone to (a) establish a local network P2P connection between the user and one or more other users' smart phone's Geo location-ally present at an establishment serviceable by a merchant, the connection allowing the users to share a paper bill generated by the merchant's POS system, (b) scan in or optically recognize the generated bill and render an electronic and interactive version of the generated bill of (a), (c) distribute a version of the electronically rendered and interactive bill of (b) to the smart phones of the one or more other users of (a), (d) receive electronic payment from the one or more other users' smart phones of (a) for a portion or portions of the bill of (c), (f) deposit the electronic payments received in (d) into at least one payment account linked to a physical payment card used to pay the bill at the merchant's POS terminal or cash register.

In this embodiment, the network is a local wireless network. Also, in this embodiment, the interactive version of the bill of (c) includes at least one interactive mechanism for enabling association of one or more other users in (d) who shared the line item or items. In a variation of this embodiment, the electronic payments received in (d) from the one or more other users' smart phones of (a) for a portion or portions of the bill of (c) include payments from different P2P accounts for one or more shared line items.

In the embodiment where the merchant has a POS system on the network, the one or more other users of (a) are running a P2P application on their smart phones and are invited to share the bill. In the embodiment where the merchant POS system generates a hard paper bill, the one or more other users of (a) are running a P2P application on their smart phones and are invited to share the bill. In the embodiment where the merchant has a POS system on a network, the payments received in (f) may include payments combining payment of a portion of a shared bill with payment of another bill or bills or portions thereof. In the embodiment where the merchant generates a hard paper bill, the payments received in (d) may include payments combining payment of a portion of a shared bill with payment of another bill or bills or portions thereof.

### BRIEF DESCRIPTION OF THE SEVERAL VIEWS OF THE DRAWINGS

FIG. 1 is a screen shot of a P2P application setup screen on a mobile phone according to an embodiment of the present invention.

FIG. 2 is a block diagram depicting elements in/of a GPS location feature of the P2P application of FIG. 1.

FIG. 3 is a block diagram depicting an application invitation feature of the P2P application of FIG. 1.

FIG. 4 is a block diagram depicting a merchant cloud-based and POS access and ordering feature of the P2P application of FIG. 1.

FIG. 5 is a screen shot depicting an order feature of the P2P application of FIG. 1 for selecting options from a merchant's digital menu through the application.

FIG. 6 is a block diagram depicting an optical character recognition (OCR) feature of the P2P application of FIG. 1 for reading a hard bill and rendering it digitally.

FIG. 7 is a block diagram depicting a bill calculation feature of the P2P application of FIG. 1.

FIG. 8 is a block diagram depicting an assignment feature of the P2P application of FIG. 1 for assigning an individual funding source account in a bill share embodiment.

FIG. 9 is a block diagram depicting a payment division feature of the P2P application of FIG. 1 for dividing a bill for an owed portion between funding sources.

FIG. 10 is a block diagram depicting a proxy pay feature of the P2P application of FIG. 1 enabling a user to pay all or part of a bill with a general peer-to-peer payment application through the P2P application of FIG. 1.

FIG. 11 is a block diagram depicting a display feature of the P2P application of FIG. 1 tallying the final payment status of a bill relative to each user.

FIG. 12 is a block diagram depicting a payment collection feature of the P2P application of FIG. 1.

### DETAILED DESCRIPTION OF THE INVENTION

In various embodiments described in enabling detail herein, the inventors provide a unique P2P bill pay/sharing application that, among other functions, enables multiple mobile users to share portions of a same bill accurately, securely, and conveniently. The present invention is described using the following examples, which may describe more than one relevant embodiment falling within the scope of the invention.

The name Divvyit is a proprietary term coined by the inventors to describe a P2P bill sharing application that may be resident on and executable from a mobile device like a mobile phone. The term Divvyit or Divvyit application may be used throughout the specification and shall be understood to refer to the bill share/pay application of the present invention.

It is a goal of the present invention to provide a bill payment application that enables bill sharing at service establishments (merchants) like bars, coffee shops, restaurants, and so on. Bill sharing is defined for the purpose of this specification as more than one user paying for a portion of a total bill. It is a further goal of the invention to provide a bill share/payment application that enables users to pay for the items they ordered and further enables more than one user to pay for an ordered item together, enabling each user to pay only a portion of an ordered item.

A further goal of the present invention is to provide a P2P bill share/pay application for mobile users that reduces or eliminates workload for merchants who manage payments from parties of multiple users. A further goal of the invention is to provide a P2P bill share/payment application that obfuscates a requirement for billing and collection of payment by a server reducing frustration for the users, reducing workload for the server charged with billing and collecting payment from the users, reducing the potential of error billing, and reducing revenue loss for the merchant.

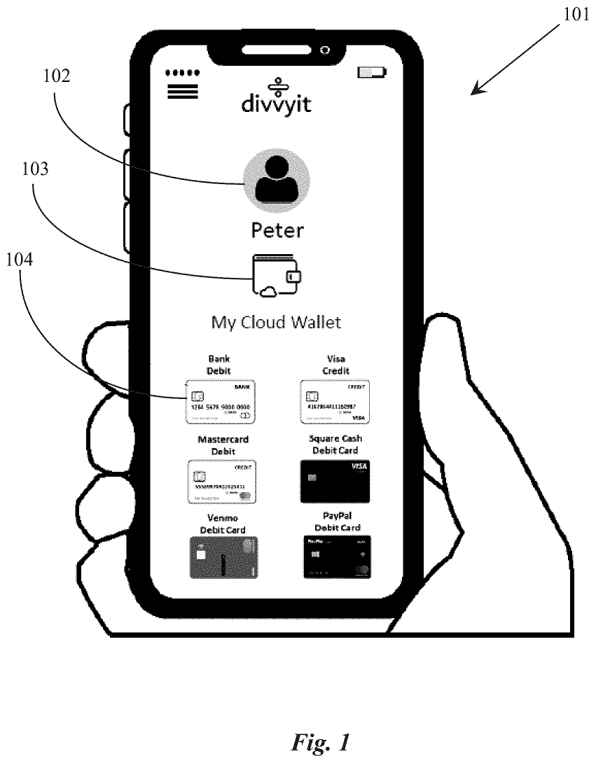

FIG. 1 is a screen shot of a P2P bill pay application setup screen on a mobile phone 101 according to an embodiment of the present invention. The displayed screen represents a “cloud wallet” (icon 103) or technical input screen for introducing multiple payment mechanisms to work within the P2P application referred to as the Divvyit application executable from and running on mobile phone 101.

A user 102 having the moniker Peter for the purposes of this description may use the depicted application screen on mobile phone 101 to enter or load in multiple payment mechanisms 104, in this case, card accounts and associated data into the cloud wallet 103 according to potentially varied methods or means. In one embodiment, a card account representing a payment mechanism 104 may be entered into the Divvyit application by taking a picture of the relevant card using the camera on mobile phone 101.

An application extension within the Divvyit application may read the card data and may trigger a browser navigation to a web-hosted version of the user's account with user authorization to verify and credit the account as potentially active for use. Card account data is automatically activated within the Divvyit application once verified. In an alternative embodiment, user 102 may enter the required account information through an input means on the mobile phone like a keyboard or microphone.

In still another embodiment, user 102 may enter a social security number while the screen is running, and the user is connected to the Internet. In this embodiment, the Divvyit application may access credit reporting firms with authorization from Peter 102. The Divvyit application may import or screen scrape the required data from the credit card companies known to the credit reporting services, the Divvyit application adapted to parse out the useful card account data from all of the accounts and adding that as separate active payment mechanisms 104. In one embodiment, user 102 may manually deactivate an account or remove data or accounts entered in but not desired by the user to be accessed.

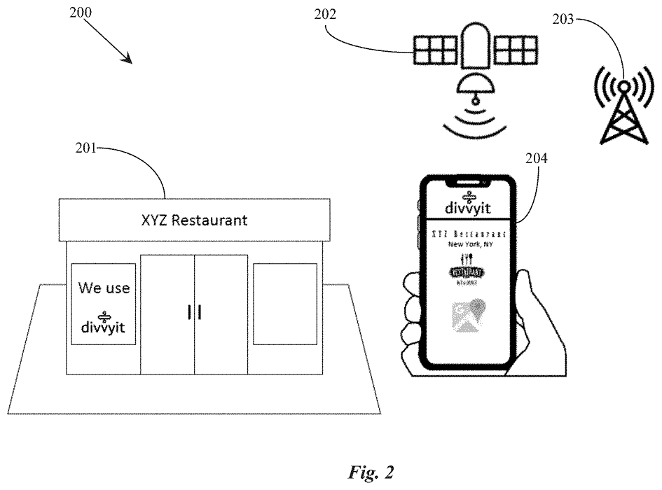

FIG. 2 is a block diagram 200 depicting elements in/of a GPS location feature of the P2P application of FIG. 1. In one embodiment of the present invention, a user operating mobile phone 204 running the Divvyit application may utilize the global position satellite (GPS) capabilities of the phone to locate a dining establishment 201 that may support the Divvyit application. GPS capability is generally referenced herein by satellite 202. In this implementation, it may be assumed that the merchants supporting the Divvyit application may be added to a database accessible to the P2P bill share/pay application of the invention.

A user operating mobile phone 204 running the Divvyit application may locate and get directions to any merchant, in this case local restaurant, by searching for example, “local restaurants” within the Divvyit application. The Divvyit application may then display a digital map of the restaurants located nearby with interactive pins showing the merchant location and distance from the user. The user may then select any listed restaurant and a route may be displayed on the map showing the directions to the user-selected restaurant.

In one embodiment, the P2P bill share/pay platform of the invention referred to herein as the Divvyit application may be adapted to utilize an available augmented global satellite positioning (A-GPS) feature. A-GPS is a GPS system that may improve the startup performance or time-to-first fix (TTFF), referring to coordinates lock of a GPS system supported by satellite 202. One with skill in the art may concur that A-GPS may draw information from a local cellular network tower like tower 203. This augmentation may enhance the performance of GPS capability in mobile phones like phone 204 and other mobile devices similarly equipped and connected to the network. A-GPS also works using mobile phone triangulation with known cellular towers to discover position when GPS satellite signals are not available to the system.

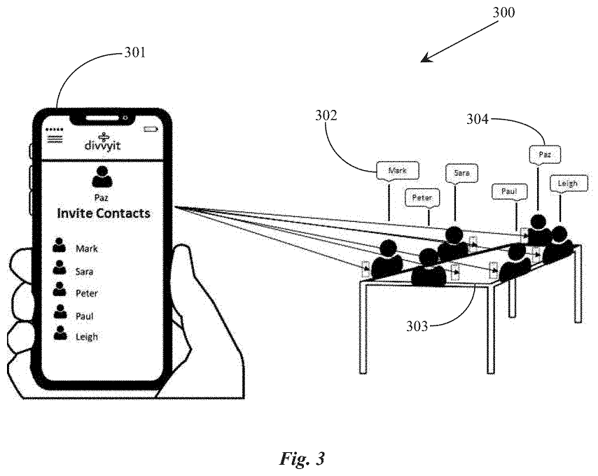

FIG. 3 is a block diagram 300 depicting an application invitation feature of the P2P application of FIG. 1. The Divvyit application running on mobile phone 301 may be adapted for manual addition and import over a network of contacts 302. Assuming contact 304 referenced as Paz is the user operating phone 301 running the Divvyit application, the set-up screen in Divvyit may prompt Paz to add contacts to a contact list for application use. Contacts may include contacts already listed in other applications that Paz (contact 304) may have on phone 301 like Email, Linkedln, Social Networks, or on another device. Contacts may be imported into a Divvyit contact list from the separate device and application over a network.

A table 303 may be assumed to be a restaurant dining table wherein contacts 302 and Paz 304 are diners or patrons in one embodiment. Assuming contacts 302 and Paz 304 are running the Divvyit application or another application enabled by Divvyit, they may all be automatically added to or at least be invited to a dining session inferred predicatively by the Divvyit platform.

The Divvyit platform may use Geo-location data observed on connected phones aggregated in close proximity combined with merchant Geo-location data to infer the session and may help shape a group session by notifying the participants already in close proximity, contacts 302 and Paz 304 of the session and asking the participants to confirm via reply active participation along with the rest of the patrons at the table. In this way, the multiple patrons are previously organized as a party at a table served by the restaurant point of sale (POS) system.

In one embodiment, a host user, for example Paz 304 running a Divvyit application on phone 301 and throwing a dinner party, may forward the contact data relative to number of contacts and Divvyit contacts that may be expected at a dinner session Paz is reserving, such as from a location remote from the merchant, for a later time to get an open dining table from the merchant for the session.

In another embodiment, Paz 304 may on whim decide to purchase a large pizza while in company of one or more of Divvyit contacts 302 and may broadcast to surrounding devices the idea of dividing the cost of a large pizza wherein the contacts 302 may opt in as a payer. There are many possibilities where parties may be automatically defined by Geo-location means, or may be defined manually by a host, or may be solicited from a crowd of potential payers without departing from the spirit and scope of the invention. The session described above is depicted as a dinner session but other scenarios are just as relevant for practicing the present invention like sharing a bar tab, sharing a golf and bar tab, sharing a chartered fishing trip, and many other examples involving a party of multiple users sharing a bill for merchant services.

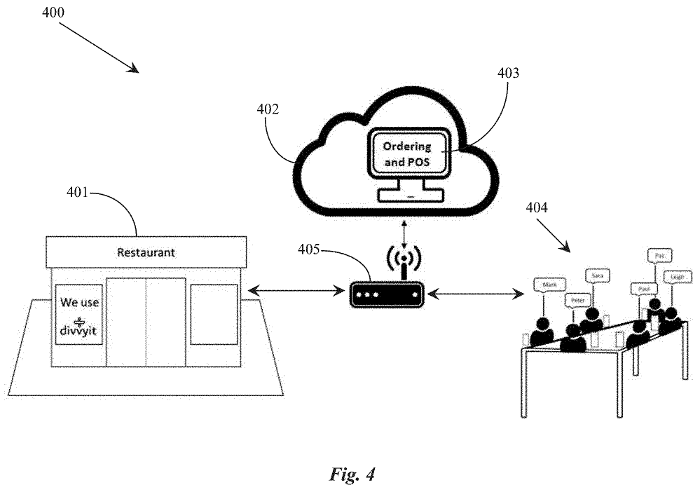

FIG. 4 is a block diagram 400 depicting a merchant cloud-based and POS access and ordering feature of the P2P application of FIG. 1. In this embodiment, it is assumed that the merchant 401 is a dining establishment, a club, or a bar that serves food and drink and that is equipped with a network hosted point of sale (POS) system. A POS system 403 is cloud-based or hosted on the Internet 402 and is accessible from an electronic device for the purpose of ordering and payment processing.

Users 404 may arrive at restaurant 401 with Divvyit applications running. When the Divvyit application confirms user location for each user, POS 403 in network 402 automatically becomes available to users through a router 405. Access to the POS system may be available over merchant WiFi capability or through a LAN (WLAN) connection or any other viable wireless protocol connection such as 5G. The Divvyit application accesses an electronic food and drink menu from the merchant POS 403 and presents the interactive menu on the user's mobile screen.

In an alternative embodiment where a merchant does not maintain a cloud-based POS system, merchant 401 may have a local network P2P payment system that may be provided as a feature of a merchant Divvyit application. In this embodiment users 403 are recognized by the merchant's Divvyit application as patrons and sends P2P interactive menus to each user to order from and the electronic bill portions for each user to pay. In one embodiment where the restaurant has an order line like a fast food chain, users 404 may already be connected to a menu and can order from their Divvyit application and are not required to stand in line or interact with a cash register.

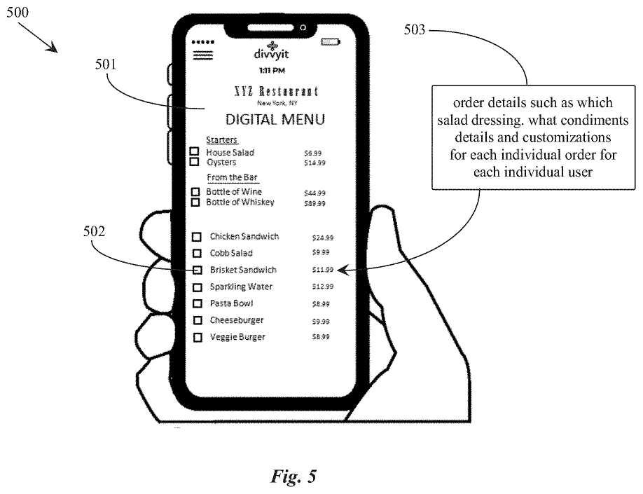

FIG. 5 is a screen shot 500 depicting an order feature of the P2P application of FIG. 1 for selecting options from a merchant's digital menu through the application. In an embodiment where the Divvyit application accesses the merchant's POS system, it is adapted to parse the basket level data referred to as line items describing menu offerings and can display those options in an electronic menu 501 in the user's Divvyit application running on the user's mobile phone.

An ordering user may select a line item for order by checking an interactive box next to the line item. In one implementation, a user may right click an item and bring up a customization window 503 in the form of an interactive dialog box, or separate screen. Customization window may take details like soup or salad, how to cook meat (rare, medium rare, well done), added side dishes, etc.

Order data from user's Divvyit application is recorded at the POS or at the Divvyit application used by the merchant per user and reproduced in a separate bill and is sent to the user from the POS system or the P2P payment application Divvyit (Divvyit enabled P2P or standalone Divvyit) used by the restaurant. When the bill is received the user may pay the bill from their phone using the Divvyit application. The Divvyit application keeps track of each order for each user separately, including the cost and suggested portion of tip.

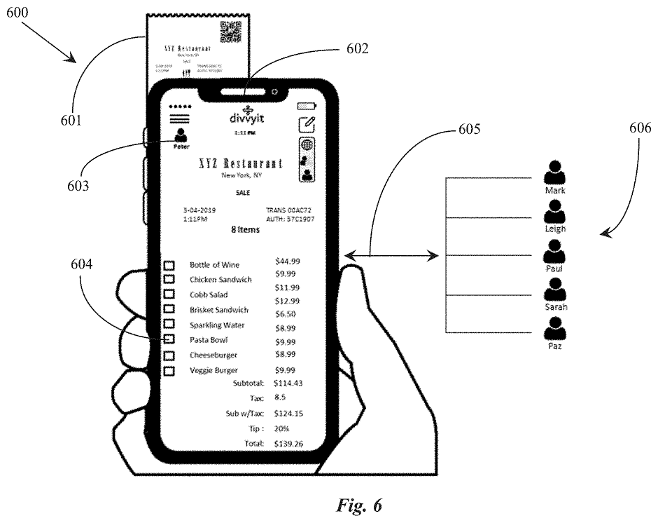

FIG. 6 is a block diagram 600 depicting an optical character recognition (OCR) feature of the P2P application of FIG. 1 for reading a hard bill and rendering it digitally. In one embodiment, the merchant (restaurant) does not have a network hosted digital platform POS or local area network (LAN) hosted Divvyit platform. Users that want to share a bill may still have the division of costs and tip calculated without relying on a restaurant server to perform the calculations.

The P2P application of the present invention may be adapted to work with an optical character recognition (OCR) platform on a mobile phone like phone 602 operated by a user 603 having the moniker Peter for discussion purposes. A hard paper bill 601 representing a group party bill may be captured electronically, in this case by Peter 603 operating mobile phone 602 aided by the Divvyit application by scanning the bill to file or image capture of the bill to file.

In one embodiment, the Divvyit application includes a software SW layer adapted for OCR machine learning that cooperates with the camera feature or scan mechanism on phone 602 to capture and to parse at least the basket level bill data for the group of users 606. The Divvyit application then renders a digital copy of the bill in a format that is interactive and automatically refreshes to the latest edited version. For example, a rendered copy of hard bill 601 is displayed in Peter's Divvyit screen with interactive boxes placed next to the served items. The line item data includes the cost charged listed per item. The subtotal, tax amount, subtotal with tax amount, tip percentage, and final total of bill 601 is displayed.

Peter selects 604 of a Pasta Bowl for $9.99 by selecting the box adjacent to that line item. The Divvyit application may place interactive check boxes next to each line item so they can be selected by each user that consumed something billed. Bill 601 may be passed wirelessly to all of users 606 over a wireless channel or link 605 after it is digitized and rendered interactive in the Divvyit application running on Peter's phone 602. The rest of the dining group 606 receives bill 601 on their smart phones enabling them to select the items they ordered. The digital bill retains each selection of each user and refreshes as each person checks what they ordered. The amount of each person's order including any customizations and tip portions may now be calculated.

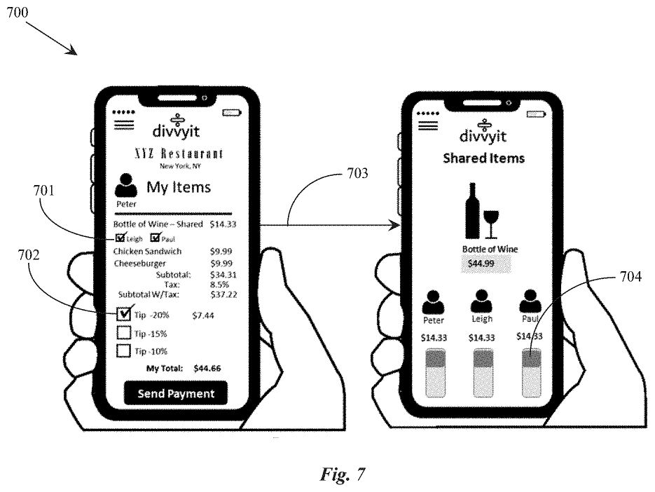

FIG. 7 is a block diagram 700 depicting a bill calculation feature of the P2P application of FIG. 1. In diagram 700, the Divvyit application running on Peter's phone (left) depicts an electronic bill accounting for Peter's owed portion of the original bill given the party. The Divvyit application may be adapted to calculate individual portions of a bill for multiple users sharing payment of the bill.

Furthermore, the application may calculate and expound granular shares of item cost for more than one user sharing an item from the bill. For example, an option 701 enables Peter to add other users to the line item bottle of wine so that the Divvyit application may divide the cost of the wine among them. In this case, Peter has added users Leigh and Paul by name informing the Divvyit application to perform a share calculation dividing the cost of the wine item by three and only charging Peter $14.33 or a third of the cost of the wine. The Divvyit application enable each user to select or call up and use an add user option 701 for any line item that is shared. The final refreshed account after all the users have finished editing their bill copies notes the items that were shared and the totals for each user.

A tip calculation option 702 in the Divvyit billing calculation for Peter allows Peter to select a tip percentage to pay for himself of a calculated total after tax to add for tipping the server. The Divvyit application calculates the selected tip rate for the subtotal and adds the tip amount to the total figure for Peter to pay. In one embodiment, each user in the party running a Divvyit application or a Divvyit enabled P2P bill share/pay application may make one or more adjustments to amounts they are paying for shared items by using the various input means of their phones like a keypad for example.

In one embodiment, the Divvyit application includes a calculation slide bar 704 enabling a user to scroll to select a price or to enter a price via text field entry reflecting an amount to pay for a shared item. In one implementation, a shared item may have cost equally divided among those sharing the item as a default setting. In another embodiment, a setting may be provided to enable a user by invitation to set an arbitrary amount for themselves that they are willing to pay for the shared item causing the application to divide equally among the remaining users that shared the item but did not request to edit the amount. It may be understood by the skilled artisan that dialog may take place between users that shared an item and that the item shares do not necessarily have to be equal but the total thereof equals the cost of the shared item.

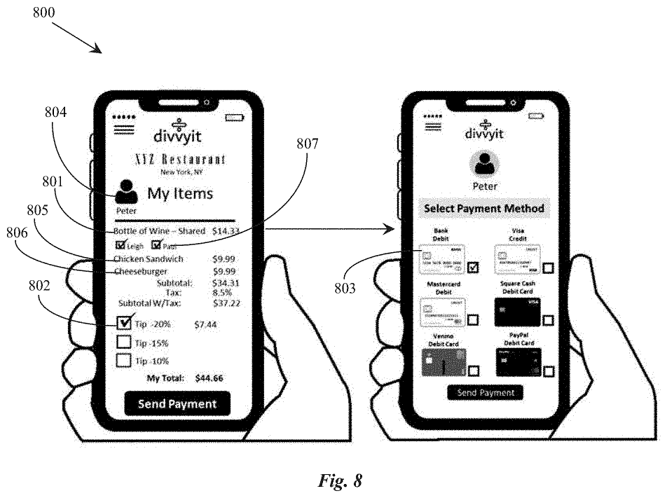

FIG. 8 is a block diagram 800 depicting an assignment feature of the P2P application of FIG. 1 for assigning an individual funding source account in a bill share embodiment. This view assumes Peter 804 (party patron) has his final total calculated for his part of the original bill for the party displayed on the Divvyit application running on Peter's phone. Peter has shared a bottle of wine item 801 with two other users 807 Leigh and Paul, has ordered a chicken sandwich item 805 and a cheeseburger item 806. Peter's portion of the tip 802 is calculated by the Divvyit application and is added to the bill to get a total that Peter owes.

Peter may have a plurality of payment accounts configured for use within his Divvyit application. Those options are depicted as displayed for selection (right) and each option is selectable by checking an interactive box placed next to each item. In this diagram view, Peter selects his bank debit card 803 to pay the bill portion with. Peter's selected card account is stored in a Divvyit network cloud service referred to further above as a cloud wallet, or it may be stored locally on Peter's phone in encrypted format the data accessed by the Divvyit application to complete a transaction by sending a payment.

In one embodiment, the merchant has the Divvyit application or a Divvyit-enabled P2P application installed on the cloud-based or network hosted POS ordering and payment system. In this embodiment each user like Peter may pay their bill portions through their applications directly to the merchant. In another embodiment, the merchant does not have the Divvyit application or a Divvyit-enabled P2P application installed in a POS system. In this embodiment, each user aside from Peter may pay their bill portions directly to Peter and then Peter may pay the party bill total. In that scenario any of the party may be the user that pays the merchant's bill.

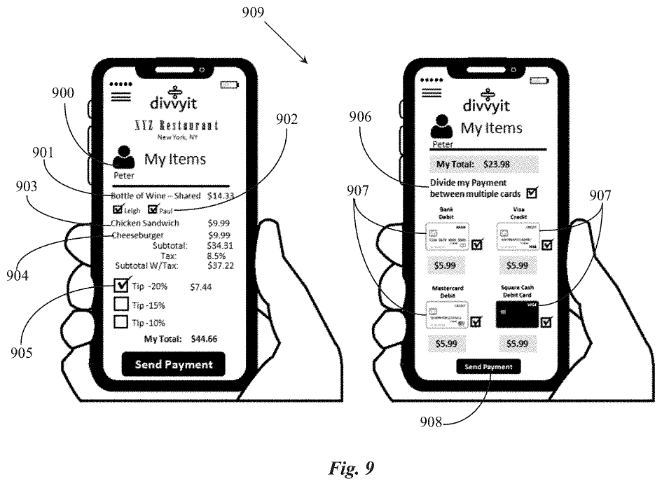

FIG. 9 is a block diagram 909 depicting a payment division feature of the P2P application of FIG. 1 for dividing a bill for an owed portion between funding sources.

In this embodiment it is assumed that the parties all pay their portions directly to the merchant through the merchant's POS system enabled for the Divvyit application. Peter 900 has Divvyit running on his smart phone (left) and displaying Peter's portion of the merchant bill analogous to the bill portion displayed in FIG. 7. For example, an option 902 enables Peter to add other users, in this case, Leigh and Paul to the line item bottle of wine. Recounting Peter's costs which are identical to those depicted in the Divvyit application on Peter's phone in FIG. 7, Peter is paying for a bottle of wine 901 shared between him and users 902, Leigh and Paul. Peter is also paying for a chicken sandwich 903 and a cheeseburger 904. The tip 905 is also calculated and added to the bill.

Peter may pay his portion of the bill from any account accessible to the Divvyit application. In one embodiment, Peter may decide to pay the bill from two or more supported accounts. For example, Peter may select a Divvyit option 906 for dividing his payment among multiple card accounts supported in Peter's Divvyit application (as Peter's accounts in his Divvyit application). In this example Peter checks four accounts 907 representing credit card accounts and or debit card accounts to divide the payment among. Peter's selected accounts may be stored in the cloud termed a Divvyit cloud wallet application, or Peter could have those accounts stored locally on his smart phone.

Peter 900 has selected to divide his payment evenly among cards 907. The user, in this case Peter, may pay the merchant directly if the Divvyit application is available on the merchant's cloud-based POS system. If the Divvyit application is not connected to the Merchant's cloud-based ordering and POS system, then the payment is sent to the user that is going to pay the bill. This embodiment Peter is paying only his portion of the bill directly through the merchant's POS system.

In one embodiment, Peter may determine specifically what portion of the bill he wants taken from each account selected. In another embodiment, the Divvyit application may, by default, split up the costs evenly unless overwrote. In this view the bill portion is split evenly at $5.99 for the four cards (each card representing one of Peter's accounts). Once the disbursement is made, Peter may submit payment by pushing the send button 908. The payment sent will be processed by the merchant's cloud-based POS and order system. If the Divvyit application is not connected to the merchant's cloud-based ordering and POS system, then the payment may be sent to the user that is going to pay the bill. If Peter is to pay the bill, then the other users send their payments to Peter and Peter submits a total payment.

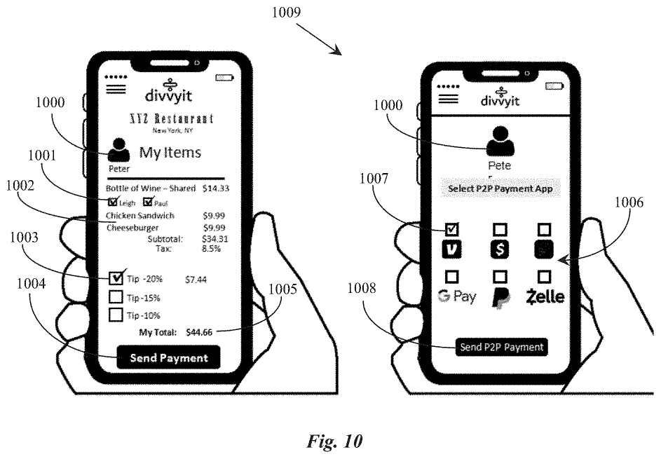

FIG. 10 is a block diagram 1009 depicting a proxy pay feature of the P2P application of FIG. 1 enabling a user to pay all or part of a bill with a general peer-to-peer payment application through the P2P application of FIG. 1. A user like Peter 1000 may decide to pay their bill or bill portion through a P2P payment application of choice. As previously described above, if the Divvyit application is connected through the merchant's cloud-based ordering and POS system, then Peter (user 1000) pays the merchant directly. If the Divvyit application is not connected to the merchant's cloud-based ordering and POS system, then the payment is sent to the user that is going to pay the bill.

Peter 1000 is paying for items from an original merchant bill for a party. Peter 1000 is paying for a bottle of wine 1001 shared by users Leigh and Paul. Peter 1000 is also paying for a cheeseburger and a chicken sandwich 1002. A tip 1003 is calculated through the Divvyit application.

Once a bill total 1005 is calculated, Peter1000 may press a send payment button 1004 which results in calling up a Divvyit application second payment screen by default because Peter has more than one P2P application, he could pay the bill through. Peter 1000 may choose to pay his portion of the bill with a P2P payment application listed with several standalone payment applications 1006 Peter has installed on his smart phone. Peter 1000 makes a choice of the P2P application Venmo 1007 to make his payment.

Peter may select the send button 1008 after selecting the P2P application from a list of applications he could pay the bill through. Peter's payment may be sent directly to the merchant or to another user dealing directly with the merchant according to the same metrics relative to merchant capabilities. If Peter 1000 has no P2P applications installed on his smart phone, then he does not get the second Divvyit screen when he hits payment submission button 1004.

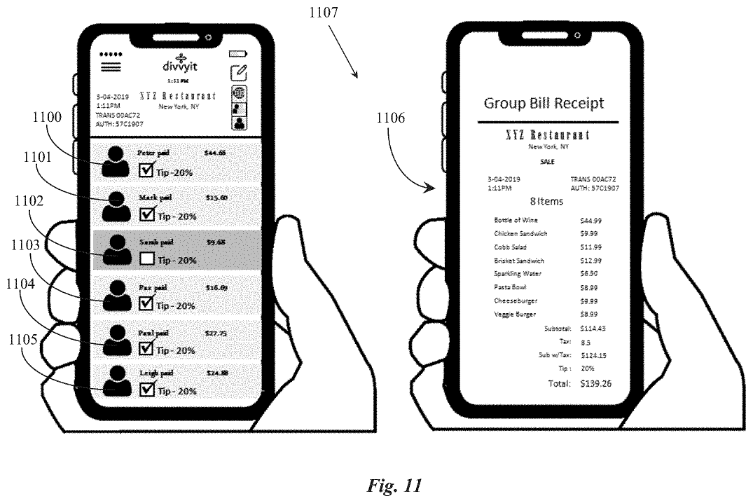

FIG. 11 is a block diagram 1107 depicting a display feature of the P2P application of FIG. 1 tallying the final payment status of a bill relative to each user. The Divvyit application keeps a running total of everyone's payment activity through the Divvyit application or any other P2P application users choose to pay their bill portion with.

A payment accounting screen lists all the users in Peter's party that paid their portion of the bill. Users other than Peter are assigned the element numbers 1101 through 1105. All users are settled except for user 1102 Sarah. If one of the party like Sarah 1102 fails for whatever reason to submit a payment for her portion of the bill total, an opportunity presents itself for the rest of the party to determine who will make up for Sarah's portion of the bill.

All bill accounting is recorded in the Divvyit application for each user identified in a party of users sharing a bill. In one embodiment, a digital equivalent of an IOU may be generated by the Divvyit application by any user in the party who does not submit payment at the time of billing for a dinner, for example. Perhaps one or more users are not leaving the establishment right after dinner and may prefer to pay their bill portions for dinner later when they are drinking and dancing at the same establishment. In this case, the group bill may be paid with one or more IOUs submitted by users who plan to stay and engage in other activities at the establishment. The amounts generated for those users may be added to a bar tab or another subsequent bill for the users and collected when they submit their payments to the bartender. Their IOU amount is added automatically by the Divvyit application to their drink tab at the end of the night for example.

A receipt 1106 (right screen) is generated after all the users have paid for their portion of the bill (with or without tip). In one embodiment, the restaurant is using a cloud-based ordering and POS system or P2P payment system and receipt 1106 can be sent directly to the Divvyit App users over the wireless link so that each user has a copy of receipt 1106.

In an embodiment where one or more of the party elect to “defer” payment submission until a final bill total has accrued for their later activities, users who paid and left the establishment may get receipt 1106 showing cost and full amount paid while some of the debit was actually “deferred” by the Divvyit application to later individual billings given to users who stayed behind and therefore preferred to pay later and at one time. The Divvyit application may be adapted to hide line item values paid for by other users on a receipt sent to a user. In that case the user who paid a portion simply receives a receipt for his or her portion.

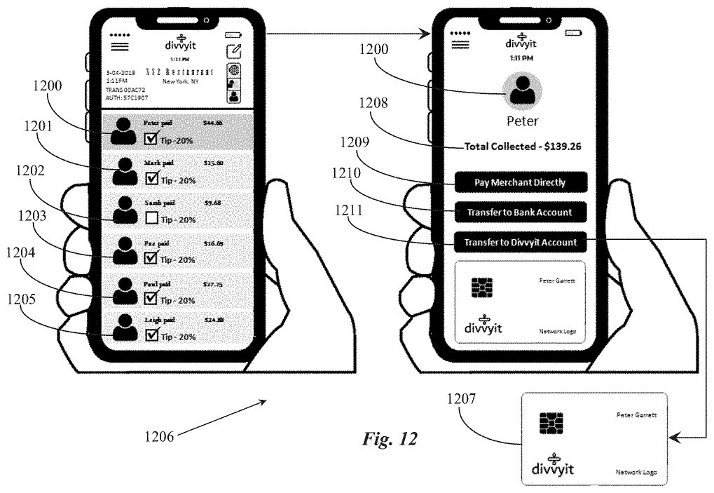

FIG. 12 is a block diagram 1207 depicting a payment collection feature of the P2P application of FIG. 1. In one embodiment of the present invention, one user may collect amounts from other users. The collecting user may then submit payment directly to the merchant (restaurant) for the meal on behalf of the users.

Peter 1200 (right screen) may collect the proportional amounts owed for a shared bill from other users 1201 through 1205 (left screen). In one embodiment, Peter 1200 has a Divvyit debit card 1207 connected to Peter's Divvyit account. The Divvyit application is adapted to manage deposits and account transfers.

Peter 1200 has collected a total 1208 of $139.26 (right screen) through the Divvyit application from the other users marked paid (left screen). Once the amounts from the other users are collected and confirmed, Peter may decide how to pay the amount to the merchant. Peter 1200 may pay the merchant directly by selecting option 1209. Peter 1200 may first transfer the collected funds to a Divvyit-registered bank account by selecting option 1210. In one embodiment, Peter 1200 may alternatively transfer the collected funds into his Divvyit linked debit card 1207 by selecting option 1211. Peter 1200 may then pay the merchant using the debit card 1207.

It will be apparent to the skilled person that the arrangement of elements and functionality for the invention is described in different embodiments in which each is exemplary of an implementation of the invention. These exemplary descriptions do not preclude other implementations and use cases not described in detail. The invention is limited only by the breadth of the claims below.

1. A peer to peer (P2P) bill sharing payment platform comprising:
a first set of coded instructions contained on a non-transitory medium resident on a user's smart phone connected to a network, the first set of code instructing the user's smart phone to:
(a) establish a local network connection between the smart phone and a merchant's point of sale (POS) system, the connection, a P2P connection allowing merchant electronic recognition of the identification of the user;
(b) receiving from the merchant's POS system over the network an interactive ordering interface, the interactive ordering interface displayed on a display device native to the smart phone;
(c) record digital input from the user activity of selecting items listed in the interactive ordering interface;
a second set of coded instructions contained on a non-transitory medium resident on a server connected to the network, the second set of code instructing the server to;
(d) receive order data over the network from the user's smart phone through the interactive order interface;
(e) generate and or send a generated electronic bill to the user's smart phone over the network; and
(f) receive payment from the user's smart phone over the network.

2. The bill sharing payment platform of claim 1, wherein the user is one of a party of users sharing the bill.

3. The bill sharing payment platform of claim 1, wherein the network is the Internet network including any local connected sub networks.

4. The bill sharing payment platform of claim 1, wherein the POS system in step (a) is a service hosted on the Internet and is a POS system subscribed to by the merchant.

5. The bill sharing payment platform of claim 1, wherein the POS system in (a) is a P2P server hosted on a local network device owned and controlled by the merchant.

6. The bill sharing payment platform of claim 1, wherein the interactive order interface of (b) includes an interactive selection mechanism associated with each line item enabling user selection of line items in the interactive order interface.

7. The bill sharing payment platform of claim 6, wherein the interactive order interface of (b) further includes an interactive mechanism for enabling addition of user data identifying one or more other users to be associated to a user-selected (selected) line item signifying to the merchant an intent to share the selected item among the added users.

8. The bill sharing payment platform of claim 1, wherein the order data received in (d) from the user's smart phone through the interactive order interface includes order data input by the user and user names of any other users sharing one or more line items with the ordering user.

9. The bill sharing payment platform of claim 1, wherein all users in a party establish the connection in (a).

10. The bill sharing payment platform of claim 1, wherein the server sends each user in a party of users a version of the bill in (e) and wherein the server receives payment from each of the users through their connected smart phones in (f).

11. The bill sharing payment platform of claim 1, wherein the server sends one user in a party of users a version of the bill in (e) and wherein the server receives payment from that user through the user's smart phone (f) and wherein the server collects the funds from more than one account held by the user to satisfy payment of the bill.

12. The bill sharing payment platform of claim 10, wherein the payments received from individual ones of the users are debited from more than one account held by those users.

13. A peer to peer (P2P) bill sharing payment platform comprising:
a set of coded instructions contained on a non-transitory medium resident on a user's smart phone connected to a network, the set of code instructing the user's smart phone to:
(a) establish a local network (P2P) connection between the user and one or more other users' smart phone's Geo location-ally present at an establishment serviceable by a merchant, the connection allowing the users to share a paper bill generated by the merchant's POS system;
(b) scan in or optically recognize the generated bill and render an electronic and interactive version of the generated bill of (a);
(c) distribute a version of the electronically rendered and interactive bill of (b) to the smart phones of the one or more users of (a);
(d) receive electronic payment from the one or more other users' smart phones of (a) for a portion or portions of the bill of (c);
(f) deposit the electronic payments received in (d) into at least one payment account linked to a physical payment card used to pay the bill at the merchant's POS terminal or cash register.

14. The bill sharing platform of claim 13, wherein the network is a local wireless network.

15. The bill sharing platform of claim 13, wherein the interactive version of the bill of (c) includes at least one interactive mechanism for enabling association of one or more other users in (d) who shared the line item or items.

16. The bill sharing platform of claim 15, wherein the electronic payments received in (d) from the one or more other users' smart phones of (a) for a portion or portions of the bill of (c) include payments from different P2P accounts for one or more shared line items.

17. The bill sharing platform of claim 1, wherein the one or more other users of (a) are running a P2P application on their smart phones and are invited to share the bill.

18. The bill sharing platform of claim 13, wherein the one or more other users of (a) are running a P2P application on their smart phones and are invited to share the bill.

19. The bill sharing platform of claim 1, wherein the payments received in (f) may include payments combining payment of a portion of a shared bill with payment of another bill or bills or portions thereof.

20. The bill sharing platform of claim 13, wherein the payments received in (d) may include payments combining payment of a portion of a shared bill with payment of another bill or bills or portions thereof.
